(19) United States
(12) Patent Application Publication
(10) Pub. No.: US 2002/0003327 A1
(43) Pub. Date: Jan. 10, 2002

(54) Vibration damping apparatus containing magnetic spring device

(76) Inventors: Yoshimi Enoki, Hiroshima (JP); Shigeki Wagata, Hiroshima (JP); Hiroki Oshimo, Hiroshima (JP); Etsunori Fujita, Hiroshima (JP); Hiroki Honda, Hiroshima (JP); Hideyuki Yamane, Hiroshima (JP)

Correspondence Address: KNOBLE & YOSHIDA, LLC, Eight Penn Center, Suite 1350, 1628 John F. Kennedy Blvd., Philadelphia, PA, 19103, US

(21) Appl. No.: 09/874,517

(22) Filed: Jun. 5, 2001

(30) Foreign Application Priority Data
Jun. 2, 2000 (JP) 2000-166592

(51) Int. Cl. F16M 11/00

(52) U.S. Cl. 267/136

(57) ABSTRACT

A magnetic spring device and a vibration damping apparatus, which are simpler and cheaper to manufacture, are disclosed. The magnetic spring device includes a plurality of stationary magnets, which are spaced apart to define a space between them, and a magnetic movable element, which is fit in the space. The magnetic poles of the stationary magnets are opposite to each other. The movable element is moved by the magnetic force generated by the stationary magnets in a parallel direction with the magnetic field. The properly positioned stationary magnets and movable element form a magnetic spring device, which together with additional properly positioned magnets alone may be used as a vibration damping apparatus. Also, when the magnetic spring device is combined with a cushioning member such as a metal spring, rubber or the like to form a vibration damping apparatus, the total elastic constant of the vibration damping apparatus may be near zero.

### BACKGROUND OF THE INVENTION

This invention relates to a magnetic spring device and a vibration damping apparatus containing the magnetic spring device, and more particularly to a magnetic spring device and a vibration damping apparatus suitable for being used as a component in the suspension unit of a vehicle seat, a boat seat, an engine mount, or the like.

A variety of damping materials, dampers and control techniques have been commonly used to reduce vibration and noise caused by a machine or an apparatus which itself is typically constructed of a low damping material in order to ensure its rigidity.

Damage to human body and its nervous system due to their exposures to vibration has become a serious problem with the ever increasing vehicle speed. Such damage shows many symptoms such as fatigue, headache, stiffness of shoulders, lumbago, amblyopia. In general, vibration isolation is achieved by a damping apparatus with properly matched springs such as metal springs, or air springs and damping materials such as rubber, viscoelastic materials or dampers. However, the dynamic magnification of the damping apparatus tends to correlate to its loss factor. More particularly, a reduction in dynamic magnification to improve low-frequency characteristics of the damping apparatus tends to reduce its loss factor, resulting in the damping apparatus being too firm. An increase in the loss factor of the damping apparatus to improve high-frequency characteristics leads to an increase in its dynamic magnification, causing the damping apparatus to be too soft and causing a poor damping efficiency at low-frequency. Many attempts have been made in the prior art to suppress vibration using a passive damper containing a dynamic vibration reducer with semi-active control or active control.

A damping apparatus containing a magnetic spring device has been recently disclosed. Also, a vibration damping apparatus having an elastic constant being substantially near zero by incorporating a damping member such as a metal spring, a rubber material is disclosed. However, the disclosed vibration damping apparatus tends to have a high manufacturing cost and require a complicated manufacturing process. Thus, it is highly desirable to develop a novel damping apparatus containing a novel magnetic spring device, which is easy and cheap to manufacture. The elastic constant of the damping apparatus containing such a magnetic spring device is substantially near zero. Such an apparatus would simplify the structure and the maintenance, and reduce the size of a suspension unit, an engine mount or the like.

Also, a magnetic spring device is often utilized in a lifting apparatus for lifting a load mass using the repulsion force between magnets. However, using the magnetic repulsion force alone is not sufficient enough to support the load mass while lifting it. Therefore, an additional linkage or a guide mechanism is needed. Unfortunately, the additional linkage or guide mechanism complicates the apparatus and increases the size of the apparatus. Also, the additional linkage or guide mechanism causes additional backlash and friction, makes the precise control of the apparatus difficult and complicates the maintenance process of the apparatus.

### SUMMARY OF THE INVENTION

The present invention has been made to overcome foregoing disadvantage of the prior art.

Accordingly, it is an object of the present invention to provide a magnetic spring device which can be used in a vibration damping apparatus.

It is another object of the present invention to provide a magnetic spring device, which, together with a cushioning member such as a metal spring, or a rubber material, can be used as a component of a vibration damping apparatus which has an elastic constant being near zero.

It is a further object of the present invention to provide a magnetic spring device which is easier and cheaper to manufacture than prior art devices.

It is still another object of the present invention to provide a magnetic circuit which can be used as a cushioning member in a vibration damping apparatus.

It is yet another object of the present invention to provide a vibration damping apparatus whose total elastic constant can be substantially near zero. It is a still further object of the present invention to provide a vibration damping apparatus which is simpler and cheaper to manufacture than the prior art apparatus.

In accordance with one aspect of the present invention, a magnetic spring device is provided. The magnetic spring device includes at least one movable element made of a magnetic material and at least one stationary magnet positioned around the movable element to define a space where the movable element can move (or travel) through. The stationary magnet moves (push or pull) the movable element through a magnetic force.

In a preferred embodiment of the present invention, a plurality of the above-described stationary magnets are spaced apart at a predetermined interval to define a space within those properly arranged magnets. The dimension of the predetermined interval is so determined that the movable element can travel through the defined space.

In a preferred embodiment of the present invention, the magnetic poles of the adjacent stationary magnets are opposite to each other.

In a preferred embodiment of the present invention, the stationary magnet has a cylindrical shape void (or space) within the stationary magnet.

In a preferred embodiment of the present invention, the stationary magnet comprises laminated magnets.

In a preferred embodiment of the present invention, the movable element comprises a permanent magnet, wherein the direction of the magnetic field (also called “magnetic direction”) of the movable element is perpendicular to the direction of magnetic field of the stationary magnet.

In a preferred embodiment of the present invention, the movable element comprises a permanent magnet which is so arranged that the direction of the magnetic field of the movable element is parallel to the direction of the magnetic field of the stationary magnet.

In a preferred embodiment of the present invention, the movable element comprises laminated magnets.

In a preferred embodiment of the present invention, the movable element comprises a ferromagnetic material. The elastic constant of the magnetic spring device the present invention containing this movable element reverses from a positive value to a negative value or vice versa when the movable element is moved (or travels) through one of several predetermined positions within a predetermined range.

In a preferred embodiment of the present invention, the movable element comprises a ferromagnetic material. The movable element reverses its magnetic poles (or polarity) when it is moved (or travels) in its moving direction.

In accordance with another aspect of the present invention, a lifting apparatus (or a supporting apparatus) is provided. The lifting apparatus includes the magnetic spring device described above. When the movable element of the magnetic spring device is moved by the stationary magnet in the direction of the magnetic force throughout a predetermined range, the elastic constant of the lifting apparatus remains positive.

In accordance with a further aspect of the present invention, a vibration damping apparatus is provided. The vibration damping apparatus includes the magnetic spring device described above. Also, it includes a cushioning member which can provide an elastic force to a load mass, which is supported on the movable element of the magnetic spring device directly or indirectly. The movable element of the magnetic spring device is moved by the magnetic force of the stationary magnet. The elastic constant of the magnetic spring device remains negative when the movable element is moved within its predetermined moving range. Therefore, the total elastic constant of the vibration damping apparatus may be substantially near zero.

### BRIEF DESCRIPTION OF THE DRAWINGS

These and other objects and many of the attendant advantages of the present invention will be readily appreciated when they become better understood by reference to the following detailed description when considered in connection with the accompanying drawings; wherein:

FIG. 1 is a schematic view showing an embodiment of a magnetic spring device according to the present invention;

FIG. 2 is a graphical representation showing the load-displacement characteristics of the magnetic spring device of FIG. 1;

FIG. 3 is a schematic view showing an example of a lifting apparatus containing the magnetic spring device of FIG. 1;

FIGS. 4(a) and 4(b) each are a schematic view showing another example of a lifting apparatus containing the magnetic spring device of FIG. 1;

FIGS. 5(a) to 5(c) each are a schematic view showing a further example of the lifting apparatus containing the magnetic spring device of FIG. 1;

FIG. 6 is a schematic view showing still another example of the lifting apparatus containing the magnetic spring device of FIG. 1;

FIG. 7 is a schematic view showing yet another example of the lifting apparatus containing the magnetic spring device of FIG. 1;

FIG. 8 is a perspective view showing a still further example of the lifting apparatus containing the magnetic spring device of FIG. 1;

FIG. 9 is a planar view showing the positioning of the stationary magnets in the lifting apparatus of FIG. 8;

FIG. 10 a front elevation view showing a vibration damping apparatus containing a magnetic spring device of the present invention;

FIG. 11 is a side elevation view of the vibration damping apparatus of FIG. 10;

FIG. 12 is a schematic sectional view of the vibration damping apparatus of FIG. 10;

FIG. 13 is a graphical representation showing a load-displacement curve indicating the static characteristics of a magnetic spring device, wherein its movable element comprises a permanent magnet;

FIG. 14 is a graphical representation showing the vibration transmission rate of a magnetic spring device which uses a permanent magnet as its movable element;

FIG. 15 is a graphical representation showing a load-displacement curve indicating static characteristics of a magnetic spring device which uses iron as its movable element;

FIG. 16 is a graphical representation showing a vibration transmission rate of a magnetic spring device which uses iron as its movable element and is applied with a vibration having an amplitude of 0.2 mm;

FIG. 17 is a graphical representation showing a vibration transmission rate of a magnetic spring device which uses iron as its movable element and is applied with a vibration having an amplitude of 1.0 mm;

FIG. 18 is a graphical representation showing a vibration transmission rate of a magnetic spring device which uses iron as its movable element and is applied with a vibration having an amplitude of 2.0 mm;

FIGS. 19(a) to 19(c) each is a schematic view showing a configuration of the stationary magnets and the movable element in a magnetic spring device;

FIGS. 20(a) to 20(d) each is a schematic view showing another configuration of the stationary magnets and the movable element in a magnetic spring device;

FIG. 21(a) is a planar view showing another embodiment of the stationary magnet; and

FIG. 21(b) is a sectional view of the stationary magnet shown in FIG. 21(a).

### DETAILED DESCRIPTION OF THE PREFERRED EMBODIMENTS

Now, the present invention will be described with reference to the accompanying drawings.

Referring first to FIG. 1, an embodiment of a magnetic spring device according to the present invention is illustrated. A magnetic spring device of the illustrated embodiment, which is generally designated as reference numeral 10 throughout this invention, includes a holding member 11 and stationary magnets 12 and 13 spaced from each other at a predetermined interval. Magnets 12 and 13 are placed on the surface of holding member 11. The directions of the magnetic field (or magnetic directions) of stationary magnets 12 and 13 are vertical in FIG. 1. Also, the magnetic poles of the stationary magnets 12 and 13 are opposite to each other (for example, the north pole of magnet 12 is adjacent to the south pole of magnet 13).

The magnetic spring device of FIG. 1 also includes a movable element 14 arranged between the stationary magnets 12 and 13 and supported on a holding member 14a made of a non-magnetic material. Movable element 14 can move through the space between the stationary magnets because they spaced apart in the predetermined interval. Optionally, the movable element 14 may comprise a permanent magnet. The magnetic field of the movable element 14 is perpendicular to that of the stationary magnets 12 and 13. The movable element 14 comprises a magnetic material. The movable magnet 14 together with stationary magnets 12 and 13 forms a magnetic spring device. Alternatively, movable element 14 may be made of any ferromagnetic material such as iron, ferrite as long as movable element 14 can be moved along the space between stationary magnets 12 and 13. In the illustrated embodiment, the direction in which the movable element 14 is moved (or in other words, the moving direction of movable element 14) is parallel with the direction of the magnetic fields of the stationary magnets 12 and 13.

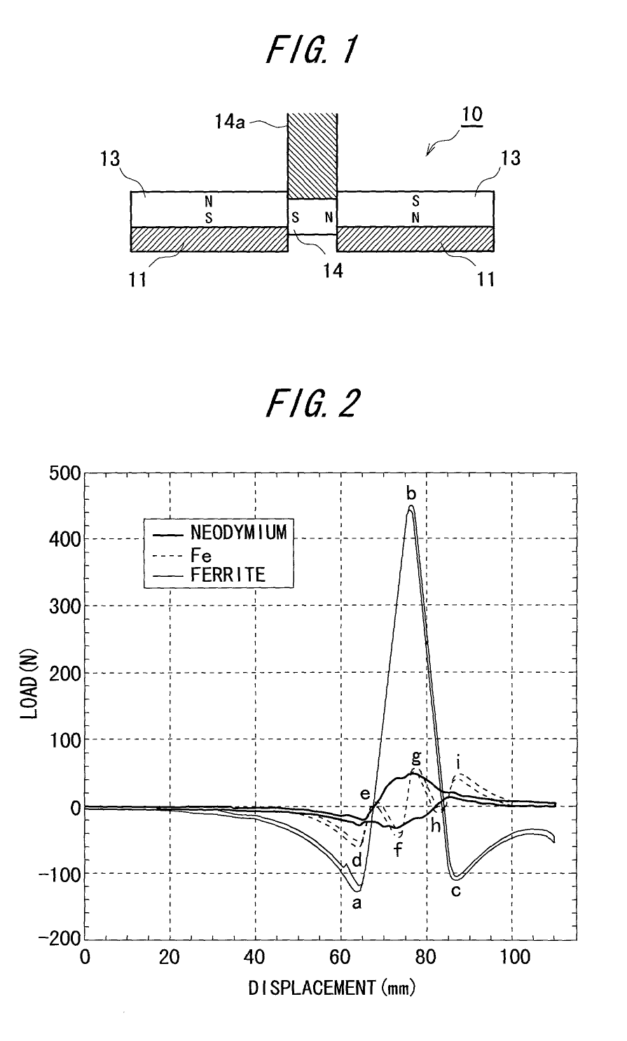

The load-displacement characteristics of the magnetic spring device 10 of FIG. 1, wherein the stationary magnets 12 and 13 has a size of 70×35×10 (thickness) and the movable element 14 has a size of 60×10×10 (thickness), was measured. The load-displacement characteristics measured are shown in FIG. 2. The stationary magnets 12 and 13 each comprise a neodymium-iron-boron magnet (hereinafter also referred to as “neodymium magnet”). A different measurement was carried out each time when the movable element 14 comprises a different material such as neodymium-iron-boron, iron (ferromagnetic material) and ferrite (ferromagnetic material).

Also, during the measurement, the stationary magnets 12 and 13 are supported on a holding member 11 as shown in FIG. 1. The holding member 11 has through hole at the position matching the space defined by stationary magnets 12 and 13. In the measurement, the load was measured in the forms of repulsion force and attraction force between the stationary magnets 12 and 13 and the movable element 14 generated during the passing movement of the movable element 14 through the space defined by stationary magnets 12 and 13 and via the through-hole of the holding member 11 in a direction parallel to the direction of magnetic fields of the stationary magnets 12 and 13. Also, the movable element 14 comprising a neodymium magnet is downwardly moved through the space between the stationary magnets 12 and 13 so that movable element 14 is initially attracted by the upper-end magnetic poles of the stationary magnets 12 and 13. For example, supposing that the upper end of the right-side stationary magnet 12 has an S pole and that of the left-side stationary magnet 13 has an N pole as shown in FIG. 1, the magnetic movable element 14 is positioned in such a way the N pole of movable element 14 is near the right-side stationary magnet 12 and the S pole of movable element 14 to be opposite to the left-side stationary magnet 13 during its initial movement. A positive value of the load indicates a repulsion force between the stationary magnets 12, 13 and the movable element 14. A negative value indicates an attraction force therebetween. The movable element 14 was moved back and forth at a speed of 100 mm/min with a maximum displacement of 110 mm.

FIG. 2 indicates that when the movable element 14 comprising a neodymium magnet approaches the stationary magnets 12 and 13, the attraction force increases substantially linearly in the region between point a, at which the attraction force is at its maximum and point b, at which the repulsion force is at its maximum. Also, FIG. 2 shows that the elastic constant, which equals the slope of the curve, of the magnetic spring device is positive. The elastic constant of the magnetic spring device is also the elastic constant of the movable element. The movable element 14 can further be moved to point c, at which the downward repulsion force is its maximum. Thus, the movable element 14 exhibits substantially linear spring characteristics and a negative elastic constant in the predetermined range between the points b and c.

When a movable element 14 comprises iron (Fe), the attraction force increases as the movable element 14 initially approaches the stationary magnets 12 and 13. The movable element 14 moves further to a predetermined point d, at which the attraction force is at its maximum (a peak). The attraction force reaches another peak at a predetermined point e, at which the spring constant reverses from a positive value to a negative value. Then, when the movable element 14 moves to a predetermined point f, the attraction force is at its maximum. Point f is a predetermined position in the direction of magnetic field generated by the stationary magnets 12 and 13. When the movable element moves to a predetermined point g, at which the elastic constant reverses from a positive value to a negative value. The attraction force reaches another peak at a predetermined point h. During the moving of the movable element 14 in its moving direction within a predetermined range of the magnetic field of the stationary magnets 12 and 13, the attraction force between the movable element 14 and the stationary magnets reaches peaks at predetermined points e and g, at which the elastic constant of the magnetic spring device reverses from a positive value to a negative value. The attraction force also reaches peaks at predetermined points d, f and h, at which the elastic constant reverses from a negative value to a positive value. Also, during the movement of the movable element 14 through the two peaks at predetermined points e and g, the elastic constant reverses from a positive value to a negative value. The movable element 14 and, therefore, the magnetic spring device, exhibit linear elastic characteristics and have a positive elastic constant within the predetermined ranges which are between the points d and e and between the points f and g and a negative elastic constant within the predetermined ranges which are between the points e and f and between the points g and h.

When the movable element 14 is made of ferrite, downward movement of the movable element 14 prevents the elastic constant from being excessively increased, although it causes repulsion force to be at its maximum at a predetermined position between the stationary magnets 12 and 13. However, the movable element 14 made of ferrite causes the reversal of the magnetic poles (or polarity) to occur between its forward movement and rearward movement during a reciprocal stroke of the movable element, to thereby exhibit the characteristics of increased hysteresis loss.

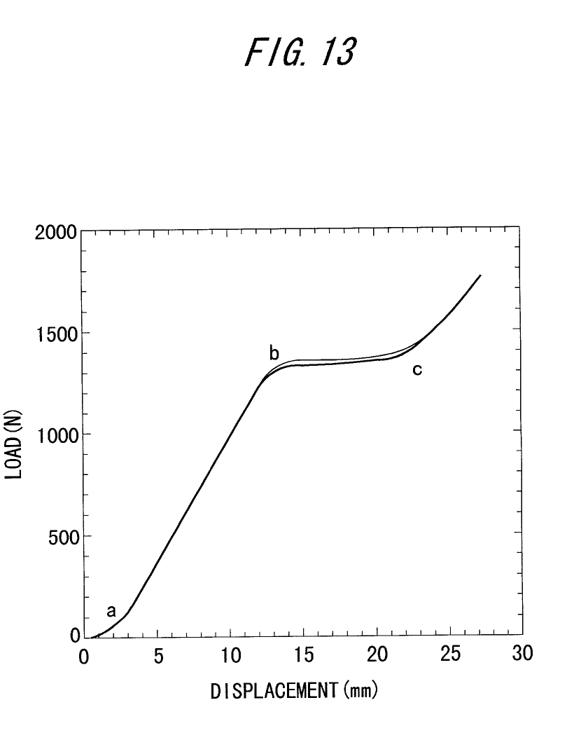

When the movable element 14 is made of neodymium or iron, it exhibits substantially the same locus between its forward movement and rearward movement during its reciprocal movement although it exhibits some characteristics different from each other as described above. Thus, being moved within a predetermined range, in which the attraction force or the repulsion force of the movable element 14 is substantially linear verse the displacement, the magnetic spring device, which comprises movable element 14 and stationary magnets 12 and 13, can be used in a lifting apparatus or a vibration damping apparatus having an elastic constant is substantially near zero. More specifically, in each case, when the movable element 14 is moved within a predetermined range, wherein the elastic constant of the magnetic spring device has a positive value, the magnetic spring device may be utilized in a lifting apparatus for raising a load mass. When movable element 14 is moved within another predetermined range, wherein the elastic constant has a negative value, the magnetic spring device may be combined with a cushioning member having a positive spring constant such as a metal spring, a rubber material or the like to form a vibration damping apparatus wherein the total elastic constant of the vibration damping apparatus is substantially near zero within the predetermined moving range of the movable element 14 (see FIG. 13).

The movable element 14 comprising a ferrite increases the hysteresis of the magnetic spring device. This causes the vibration damping apparatus comprising the magnetic spring device to have an elastic constant substantially different from zero. Nevertheless, such a vibration damping apparatus still exhibits increased damping force due to the reversal of the magnetic poles during the movement of movable element 14. Thus, the movable element made of ferrite may be used as a magnetic spring device. Alternatively, depending on the load mass, the movable element may be combined with a cushioning member such as a metal spring or the like to effectively provide a vibration damping apparatus.

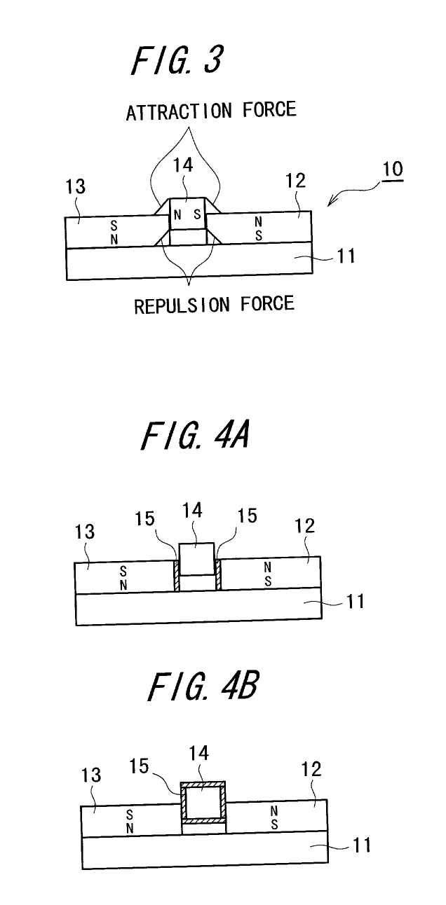

FIGS. 3 to 7 each schematically shows the embodiments a lifting apparatus comprising the magnetic spring device 10. In FIG. 3, the movable element 14 comprises a permanent magnet (neodymium magnet). Also, the stationary magnet 12 arranged on the right-hand side has its N pole on its upper end and the stationary magnet 13 on the left-hand side has its S pole on its upper end. Further, the holding member 11 is positioned under the stationary magnets 12 and 13 to support them. In addition, in order to permit the movable element 14 to be moved or displaced in an upward direction, the permanent magnet in the movable element 14 is so arranged that the S pole of the permanent magnet is opposite to the right-side stationary magnet 12 and the N pole is opposite to the left-side stationary magnet 13. Such arrangement causes a repulsion force between the S pole of the right-side stationary magnet 13 on its lower end and the S pole of the movable element 14 and between the N pole of the left-side stationary magnet 13 on its lower end and the N pole of the movable element 14, resulting in the movable element 14 being lifted and pushed up by the stationary magnets 12 and 13. Then, the pushed up movable element 14 starts to experience the attraction force between the upper-end N pole of the right-side stationary magnet 12 and the S pole of the movable element 14 and between the upper-end S pole of the left-side stationary magnet 13 and the N pole of the movable element 14. These repulsion force and attraction force eventually are balanced out with each other, so that the movable element 14 may be stably supported while being kept raised by a predetermined distance from the supporting element 11. Such a balanced position or a position at which the movable element 14 is stably supported while being raised is represented in FIG. 2 as the intersection point between the curve from points a to b and the horizontal axis, at which the load is zero.

The lifting apparatus comprising the magnetic spring device 10 is capable of stably raising the movable element 14 without any additional means such as a linkage, a guide mechanism. Thus, the lifting apparatus has a simpler structure, a smaller size and a lower manufacturing cost than a conventional lifting apparatus. The lifting apparatus of the present invention facilitates its maintenance because it eliminates the necessity of including any additional means as described above.

It is not required to exactly match the width of the movable element 14 to the space between the stationary magnets 12 and 13 so long as the movable element 14 can be moved through the space. However, when the width of the movable element substantially matches the space as shown in FIG. 3, the stationary magnets 12 and 13 can also act as a guide for the movable element 14 during its movement. Also, in order to ensure the smooth movement of the movable element 14 through the space between the stationary magnets 12 and 13, the inner surface of each of the stationary magnets 12 and 13 or the outer surface of the movable element 14 may be coated with a material 15 such as PTFE (polytetrafluoroethylene) to further reduce the frictional resistance therebetween (as shown in FIGS. 4(a) and 4(b)).

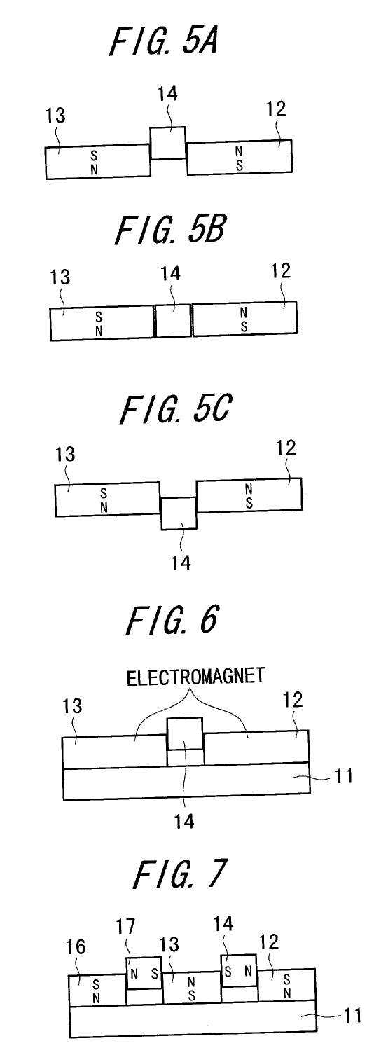

When the stationary magnets 12 and 13 and movable element 14 each comprises a single layer permanent magnet, the movable element 14 can be moved in either direction depending on the polarities of the movable element 14 opposite to the stationary magnets 12 and 13. When the movable element 14 is made of a ferromagnetic material such as iron, the direction of magnetic field of the movable element 14 which magnetized by the magnetic field generated by the stationary magnets 12 and 13, as shown in FIGS. 5(a) to 5(c), permits the movable element 14 to be stably held while being moved in both upward and downward directions even when the magnets 12 and 13 are single layer magnets. Thus, the movable element 14 is balanced at each of the intersections between the curve from points f to g and the horizontal axis at which the load is zero and that between the curve from points h to i and the horizontal-axis at which the load is zero as shown in FIG. 2.

In the above-illustrated embodiment, each of the stationary magnets 12 and 13 comprises a permanent magnet. Alternatively, an electromagnet may be used in substitution of the permanent magnet as shown in FIG. 6. The usage of the electromagnet permits the movement of the movable element 14 to be controlled by a switch which controls the current being fed into the electromagnet. Also, in the illustrated embodiment in FIG. 6, the movable element 14 is arranged in the space between such two stationary magnets 12 and 13, which are spaced from each other at a predetermined interval. The predetermined interval is so determined that the movable element 14 can move (or travel) through the space defined by the stationary magnets. The magnets 12 and 13 are placed on the holding member 11.

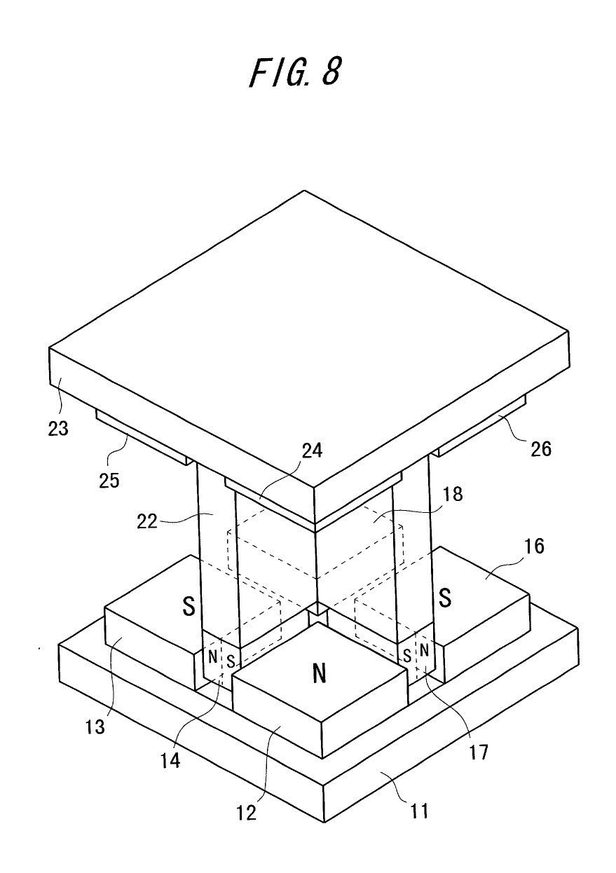

Alternatively, the above-illustrated embodiments may be constructed in such a manner as shown in FIG. 7. More particularly, three such stationary magnets 12, 13 and 16 are placed on a holding member 11 while the adjacent stationary magnets are spaced from each other at predetermined intervals. Also, two movable elements 14 and 17 are placed in the spaces between the stationary magnets 12 and 13 and between the stationary magnets 13 and 16, respectively. Additional stationary magnets and movable elements may be arranged in a similar manner.

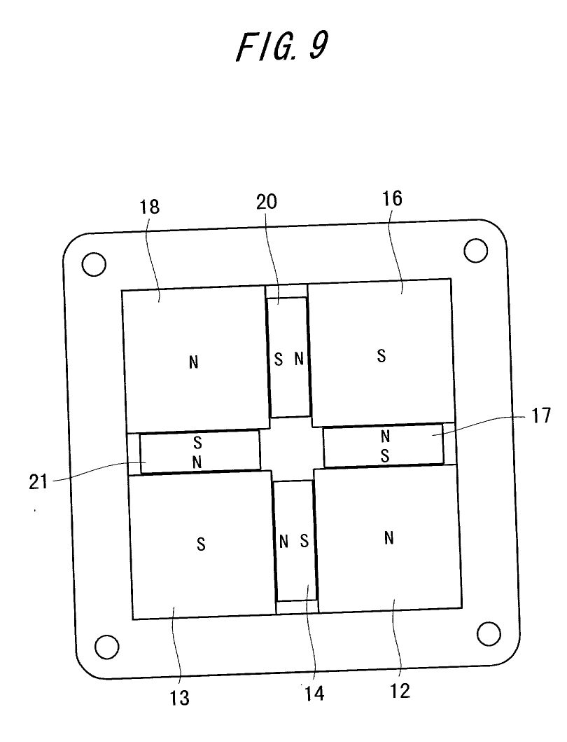

Arrangement of the stationary magnets and movable element(s) in the magnetic spring device 10 is not just limited to the arrangement shown in above embodiments in which the magnets are juxtapositional to each other in a row. The arrangement may also be carried out as shown in FIGS. 8 and 9, for example. More specifically, four stationary magnets 12, 13, 16 and 18 are arranged on the holding member 11 in a lattice-like manner so that each adjacent two stationary magnets may be spaced from each other at an equal interval and have their polarities being opposite to each other. Then, movable elements 14, 17, 20 and 21 comprising permanent magnets are arranged in the spaces between every two stationary magnets. The magnetic field direction of the movable elements 14, 17, 20 and 21 is perpendicular to the direction of magnetic field of the stationary magnets. In this instance, in order to ensure that four such movable elements 14, 17, 20 and 21 move through the spaces between those stationary magnets simultaneously, the movable elements 14, 17, 20 and 21 may be supported on a holding member 22 which has a cruciform configuration. The support member 22 is preferably made of a non-magnetic material such as synthetic resin or the like.

When the magnetic spring device 10 may be used as a lifting apparatus, the support member 22 may be further connected to a base 23 at the surface which is opposite to the surface where the movable elements 14, 17, 20 and 21 are attached. Four additional permanent magnets 24, 25, 26, and a fourth one, (omitted from FIG. 8 for the sake of brevity), may be arranged on the base 23. The additional four magnets have the same polarities as the stationary magnets 12, 13, 16 and 18. The polarities of the additional four permanent magnets 24, 25 26, and the fourth one are opposite to each other. This permits a repulsive magnetic field to be generated between the stationary magnets 12, 13, 16 and 18 and the permanent magnets 24, 25, 26 and the fourth one, so that the movable elements 14, 17 20 and 21 may be more stably supported while being raised.

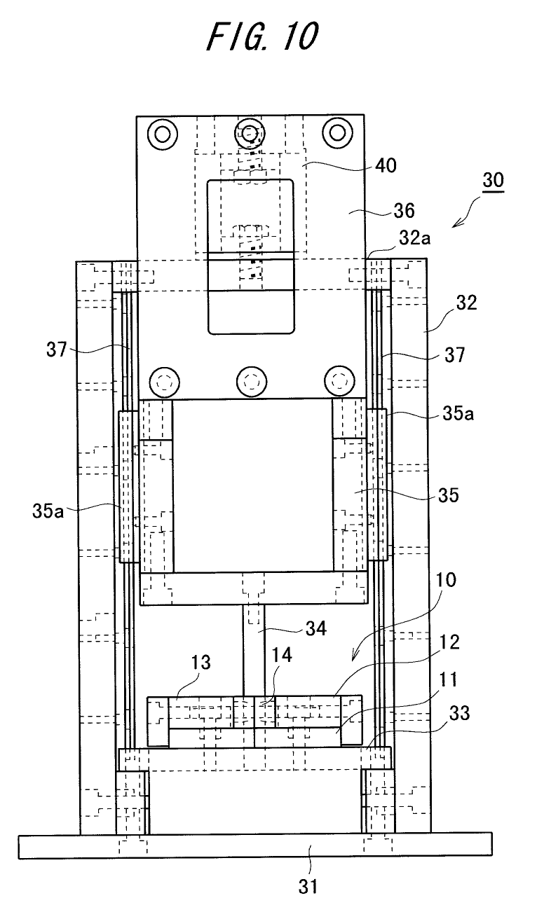

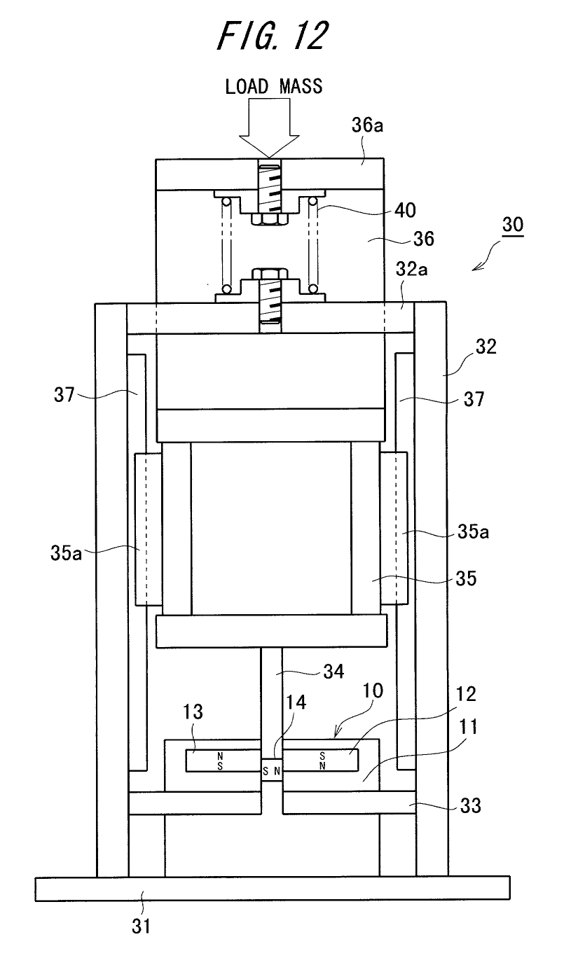

Now, a vibration damping apparatus in which the magnetic spring device of the present invention is incorporated will be described with reference to FIGS. 10 to 12. FIGS. 10 to 12 show a vibration damping apparatus 30 comprising the above-described magnetic spring device 10. In FIGS. 10 to 12, reference numeral 31 designates a base plate. In practice, the base plate 31 is mounted on a frame of a car body or the like. In a vibrating test of the vibration damping apparatus 30, the base plate 31 is mounted on a table (not shown) of a test apparatus. The base plate 31 is mounted on to the table with a housing 32 of a box-like shape. The front and rear walls of the housing 32 are open. The housing 32 has a pedestal 33 fixed on the table inside the housing 32 near the bottom of the housing 32. The magnetic spring device 10 comprising the stationary magnets 12 and 13 are supported on the pedestal 33. More specifically, the holding member 11 comprising a non-magnetic material and acting as the support member is fixed on the pedestal 33. The stationary magnets 12 and 13 are fixed on the holding member 11 and are spaced from each other at a predetermined interval so that the movable element 14 can be positioned and fit between the stationary magnets 12 and 13.

The movable element 14 is held on the distal or lower end of a connection rod 34, whose upper end is connected to one end of a vertically moving member 35. The other end of the vertically moving member 35 is connected a load mass support member 36. The load mass support member 36 can support a load mass on its upper portion. Slide guides 35a are attached to the both sides of the vertically moving member 35. The slide guides 35a can slide freely on each of rail members 37 which are vertically positioned in the housing 32, to thereby stabilize the vertical movement of the vertically movable member 35.

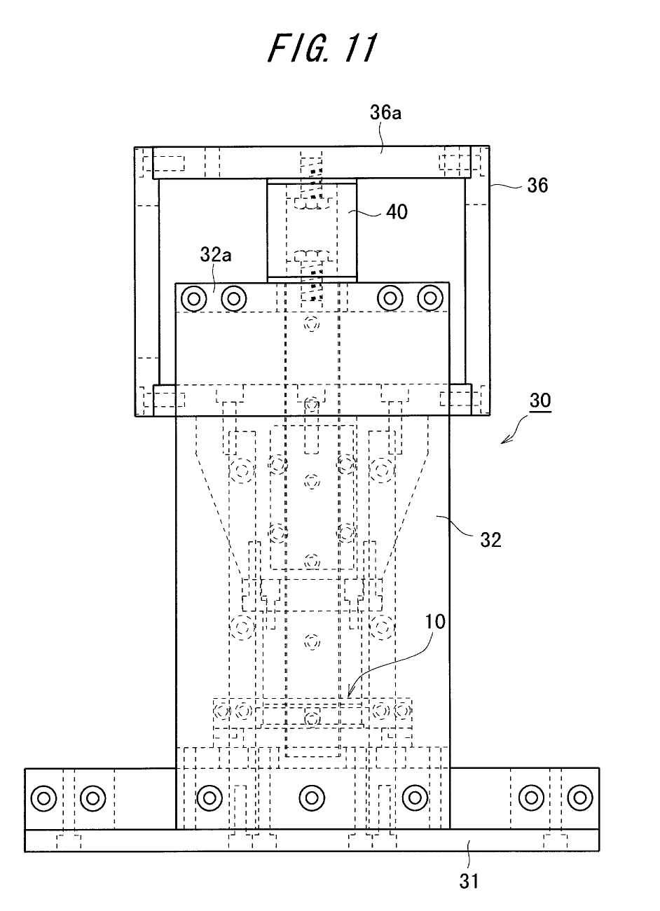

The load mass support member 36 is formed into a substantially U-shape and connected to the vertically moving member 35. The load mass support member 36 covers and surrounds an upper wall 32a of the housing 32 because of its U-shape as shown in FIGS. 10-11. The load mass support member 36 includes an upper wall 36a. There is a space between the upper wall 36a and the upper wall 32a of the housing 32. The vibration damping apparatus 30 includes a coiled spring 40 fit in the space between the upper walls 32a and 36a. The coiled spring 40 functions as a cushioning member which can elastically deform in the moving directions of a load mass supported by the connection rod 34, vertically movable member 35 and load mass support member 36. The coiled spring 40 can also deform in the moving direction the movable element 14 when the movable element 14 moves relative to the stationary magnets 12 and 13 (or the moving direction of the movable element 34). The cushioning member may be made of a metal spring, a rubber material or the like. Arrangement of the coiled spring 40 is not limited to any specific manner so long as it is elastically deformable substantially in the direction of relative movement of the movable element 14. For example, it may be positioned inside the housing 32.

FIG. 13 shows the test data using a load-displacement curve which indicates static characteristics of the above-described vibration damping apparatus 30, in which the movable element 14 comprises a neodymium-iron-boron magnet (neodymium magnet). As will be noted from FIG. 13, elastic force of the coiled spring 40 exhibits a positive linear elastic constant within the range between points b and c in FIG. 2. In the same region the magnetic spring device 10 has a negative elastic constant. Therefore, the elastic force is not substantially varied in the range between the points b and c regardless of the displacement or position of the movable element 14 as shown in FIG. 13. This results in the total elastic constant of the vibration damping apparatus 30 being substantially near zero as indicated by the slope of the curve. Thus, the elements in the apparatus 30 are so chosen that the displacement region of the movable element 14 relative to the stationary magnets 12 and 13 in the magnetic spring device 10 supporting a load mass coincides with the range between the points b and c in FIG. 2. The elements in the apparatus 30 is so adjusted that the elastic constant of the coiled spring 40 and the absolute value of the elastic constant of the magnetic spring device 10 within the range between the points band c in FIG. 2 are substantially equal to each other. Therefore, the transmission of vibration may be effectively reduced or eliminated while keeping the total elastic force substantially constant.

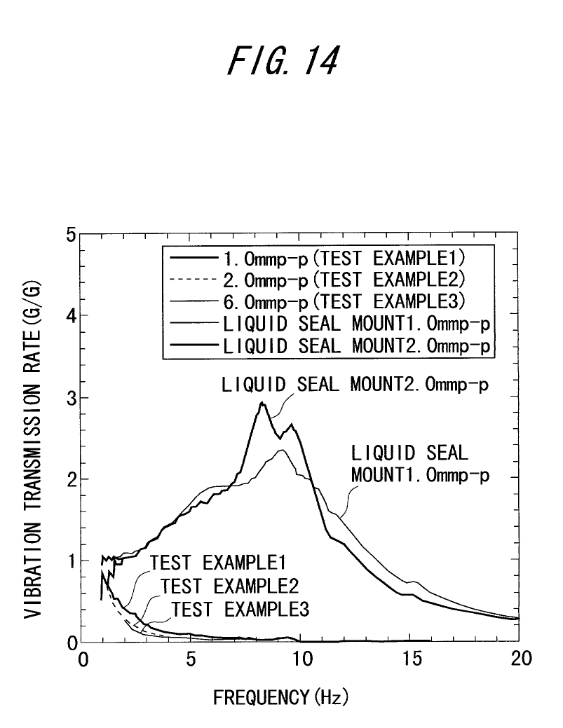

FIG. 14 shows the vibration transmission characteristics of the vibration damping apparatus 30. In FIG. 14, data from Test Examples 1 to 3 of the vibration damping apparatus 30 are illustrated, wherein the movable element 14 used in the test of FIG. 13 comprises a neodymium magnet. During the test, the movable element 14 is initially set at a position substantially middle in the range between the points b and c in FIG. 2 while bearing a load mass on the load mass support member 36 and then fix the base plate 31 on the table of a vibrating apparatus. The vibration transmission rate on the load mass at various frequencies is measured. Also, for comparison, the vibration transmission rate was measured using a conventional “liquid seal mount”. The conventional “liquid seal mount” is a damping apparatus, in which liquid is sealed in a rubber mount which is normally used as an engine mount to support a predetermined magnitude of mass. In FIG. 14, for example, “1.0 mm p-p” means that the distance between the first furthest point obtained when the load mass is deflected in one direction during vibration and the second furthest point obtained when it is deflected in the other direction is 1.0 mm during vibration.

As will be apparent from FIG. 14, each of Test Examples 1 to 3 on the vibration damping apparatus 30 of the illustrated embodiment shows a significant reduction in vibration transmission rate as compared with the conventional liquid seal mount (Comparative Examples). In particular, in every Test Examples the resonance peak is moved to a lower-frequency region than Comparative Examples. Therefore, vibration over a wide range above 3 Hz which can be felt by a human body is greatly reduced.

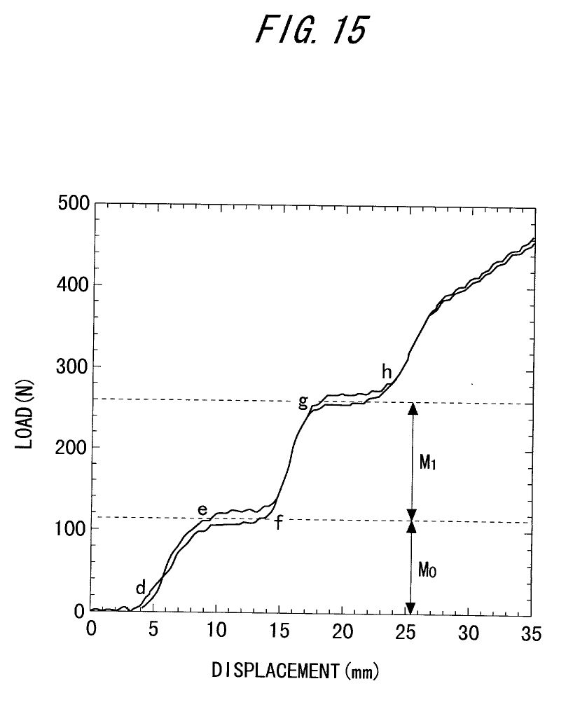

FIG. 15 shows data on a load-displacement curve indicating static characteristics of the vibration damping apparatus 30 wherein the movable element 14 of the magnetic spring device 10 in the vibration damping apparatus 30 is made of iron, which is a ferromagnetic material. The test was carried out in a substantially same procedure as that in FIG. 13. The movable element 14 made of iron shows a negative elastic constant at two points (shown in FIG. 2). Thus, as will be noted from FIG. 15, there are two ranges (between the points e and f and between the points g and h in FIG. 2) where the magnetic spring device 10 exhibits a negative elastic constant and the coiled spring 40 exhibits a positive linear spring constant. In these two regions, elastic force (or load) is kept substantially constant regardless the magnitude of the displacement of the movable element 14. Therefore, the total elastic constant indicated by the slope of the curve may be substantially near zero.

The elements in the vibration damping apparatus 30 is so chosen that the region of displacement of the movable element 14 relative to the stationary magnets 12 and 13 in the magnetic spring device 10 while supporting different load masses M₀ or M₀+M₁ coincides the region between the points e and f or g and h in FIG. 2 respectively. In the mean time, adjustment to those elements can be carried out so that the elastic constant of the coiled spring 40 and the absolute value of the elastic constant of the magnetic spring device 10 in the range between the points e and f or between points g and h in FIG. 2 substantially equal to each other. The elastic force (or load) can be kept relatively constant within each region. Therefore, transmission of vibration may be effectively reduced or eliminated.

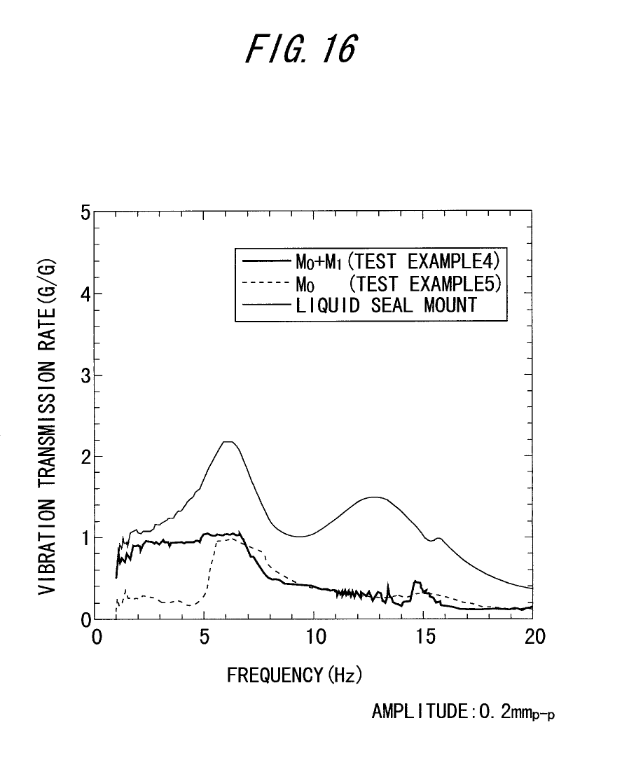

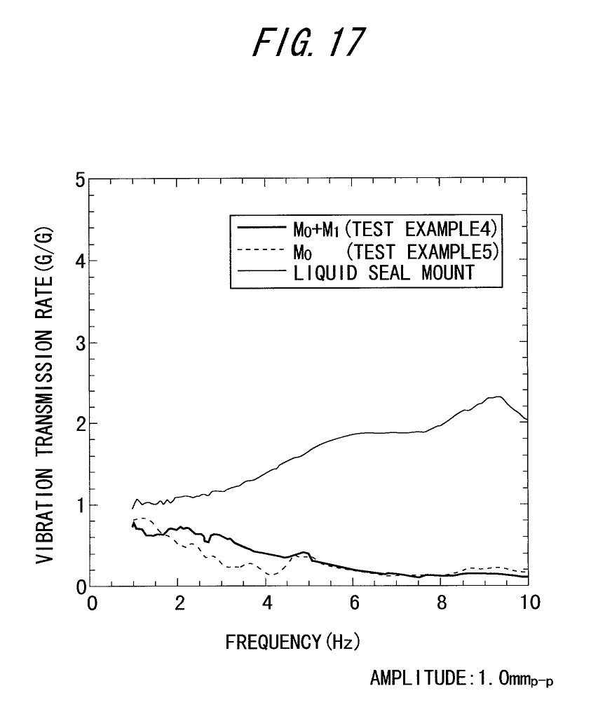

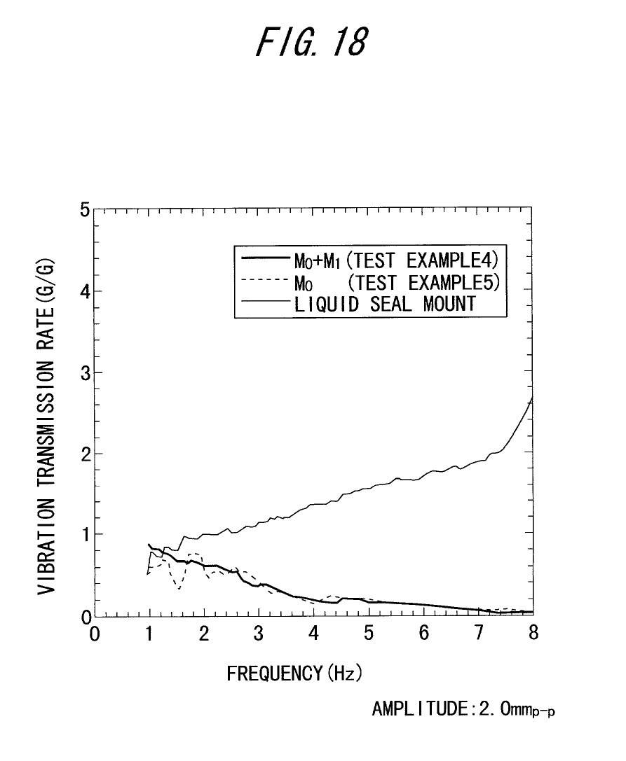

FIGS. 16 to 18 each shows vibration characteristics of the vibration damping apparatus 30 wherein the movable element 14 of the magnetic spring device 10 in the vibration damping apparatus 30 is made of iron. Measurement of the vibration characteristics was made while varying the vibration amplitude from 0.2 mm, to 1.0 mm, to 2.0 mm. Results on Test Example 4 were measured while the load mass was set at M₀+M₁. Results on Test Example 5 were obtained while the load mass was set at M₀. Comparative results are measured when a load mass was supported on a liquid seal mount. All these results are shown in FIGS. 16 to 18 (Comparative Examples). These tests were carried out in substantially the same manner as those in FIG. 14.

FIGS. 16-18 clearly indicate that the vibration damping apparatus of the present invention is effective in reducing vibration transmission rate. They also show that this apparatus accomplishes vibration damping more effectively than the prior art apparatus.

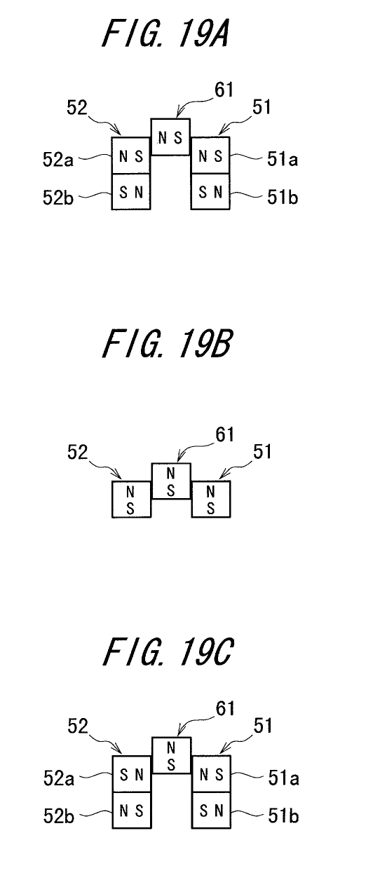

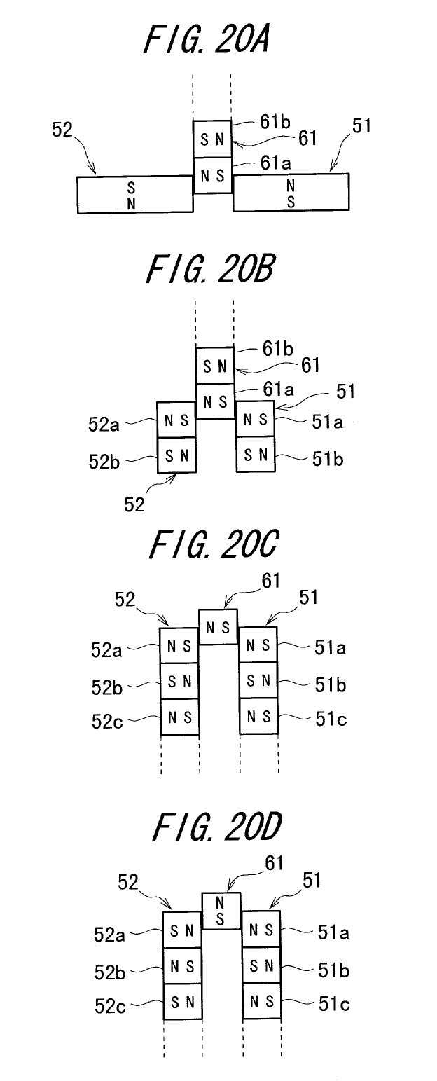

The magnetic spring device and vibration damping apparatus of the present invention are not limited to the above-described embodiments. For example, the stationary magnets and the movable element incorporated in the magnetic spring device and their arrangement may be configured and arranged in such a manner as shown in FIGS. 19(a) to 20(d). In each of FIGS. 19(a) to 20(d), the magnetic force being applied to the movable element by the stationary magnets varies depending on the position to which the movable element is moved. Therefore, the movable element may be pushed or pulled in either direction. This makes magnetic spring device versatile. Thus, the devices shown in each of FIGS. 19(a) to 20(d) can be incorporated into a lifting apparatus or vibration damping apparatus to simplify the manufacture of these apparatus.

More specifically, arrangement shown in FIG. 19(a) is so configured that stationary magnets 51 and 52 are spaced apart from each other. The stationary magnet 51 comprises two magnets 51a and 51b laminated together. The stationary magnet 52 comprises two magnets 52a and 52b laminated together. The magnetic direction of the magnets 51a and 51b and magnets 52a and 52b conforms to the direction of arrangement these magnets. The movable element 61 is arranged between the stationary magnets 51 and 52 so that the magnetic direction of the movable element is parallel to the magnetic direction of the magnets 51a, 51b and magnets 52a, 52b.

Arrangement shown in FIG. 19(b) is so configured that the magnetic directions the stationary magnets 51 and 52 and the movable element 61 are vertical. In arrangement of FIG. 19(c), the stationary magnets 51 and 52 are formed by laminating two magnets 51a and 51b on each other and laminating two magnets 52a and 52b on each other, respectively, as in FIG. 19(a). The magnetic direction of movable element 61 is perpendicular to the magnetic field of the magnets 51a, 51b and 52a, 52b of the stationary magnets 51 and 52.

In FIG. 20(a), the magnetic direction of the movable element 6 is perpendicular to the magnetic direction of the stationary magnets 51 and 52 as in FIG. 1. However, FIG. 20(a) is different from FIGS. 1 in that the movable element 61 is formed by laminating two magnets 61a and 61b on each other. Such construction of the movable element 61 permits the movable element 61 to have a plurality of peaks at which the elastic constant of the movable element reverses between a positive value and a negative value in the range of displacement of the movable element 61. The movable element 61 may exhibit substantially the same function and advantage as those made of a ferromagnetic material such as iron as shown in FIG. 5.

In FIG. 20(b), the stationary magnets 51 and 52 are formed by laminating two magnets 51a and 51b on each other and laminating two magnets 52a and 52b on each other, respectively, as in FIG. 19(a). Also, the movable element 61 is likewise formed by laminating two magnets 61a and 61b on each other. In FIG. 20(c), the stationary magnets 51 and 52 are respectively formed by laminating three magnets 51a, 51b and 51c on each other and laminating three magnets 52a, 52b and 52c on each other. In FIG. 20(d), the stationary magnets 51 and 52 are formed by laminating three magnets 51a, 51b and 51c on each other and laminating three magnets 52a, 52b and 52c on each other, respectively. Further, the magnetic field of the movable element 61 is perpendicular to that of the magnets 51a, 51b, 51c, 52a, 52b and 52c. The above-described arrangement shown in each of FIGS. 20(b) to 20(d) permits repulsion force to be changed at a plurality of points within the range of displacement of the movable element 61. Therefore, the movable element 61 may have a plurality of peaks at which the elastic constant reverses between a positive value and a negative value.

In the arrangement shown in each of FIGS. 19(a) to 20(d), the stationary magnets and/or movable element are formed by laminating a plurality of magnets. The number of magnets that can be laminated is not limited to any specific range.

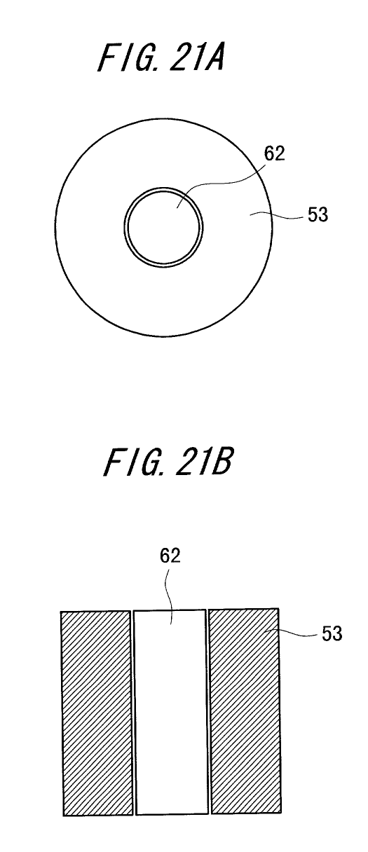

Also, when the stationary magnets comprise different magnets as shown in FIG. 1, it is required that they interpose the movable element therebetween in the direction of their arrangement. Alternatively, the illustrated embodiment may be configured in such a manner as shown in FIG. 21. More specifically, a stationary magnet 53 is formed into a cylindrical shape such as a circular cylindrical shape, a rectangular cylindrical shape or the like to provide an internal void 53a therein, which acts as a passage for a movable element 62. In such a cylindrical configuration, the stationary magnet 53 and movable element 62 may be arranged in any suitable manner or layout. In this regard, when the stationary magnet 53 has a rectangular cylindrical shape, it is subjected to a configuration restriction, resulting in being limited to such arrangement as shown in FIG. 19(b), FIG. 19(c) or FIG. 20(d) wherein magnetic poles are symmetric from each other with the movable element 62 being interposed therebetween.

In addition, the vibration damping apparatus 30 of the illustrated embodiment contains the coiled spring 40 to act as a cushioning member. However, the coiled spring 40 is not limited to the metal spring as described above. A rubber material or the like can also be used as a coil spring 40 as long as it exhibits an elastic force substantially in the moving direction of the load mass. For example, as shown in FIG. 8, the permanent magnets 24, 25,26 and the fourth one may be arranged on the stationary magnets 12, 13, 16 and 18 of the magnetic spring device 10 in a manner to render the same polarities thereof opposite to each other, to cause a repulsion force formed therebetween. The permanent magnets 24, 25, 26 and the fourth one form a magnetic circuit, which may be used as a cushioning member. The cushioning member comprising the magnetic circuit and magnetic spring device 10 form a vibration damping apparatus 30. In this instance, the thus-provided cushioning member is hard to exhibit linear spring characteristics as compared with a metal spring or the like. However, The intensity of the magnetic fields generated by each of the stationary magnets 12, 13, 16 and 18. The movable elements 14, 17, 20 and 21 in the magnetic spring device 10, the permanent magnets 24, 25 and 26 in the cushioning member, and the stationary magnets can be properly adjusted so that the total elastic constant of the vibration damping apparatus 30 is substantially near zero. When the cushioning member comprises such a magnetic circuit, the whole vibration damping apparatus may contains magnets only. This further simplifies the construction of the vibration damping apparatus and facilitates the maintenance of the vibration damping apparatus. The arrangement and the number of stationary magnets and permanent magnets in the magnetic cushioning member may be varied as required. Thus, they are not limited to FIG. 8.

As can be seen from the foregoing, the magnetic spring device of the present invention is so constructed that the stationary magnets comprising a magnetic material are spaced apart to form a passage for the movable element. The magnetic force generated by the stationary magnets can push or pull the movable element. Due to the configuration of the magnetic circuit (or magnetic cushioning member) disclosed in the present invention, a vibration damping apparatus can be solely made from the stationary magnets and the movable element which are properly arranged. Also, the total elastic constant of a vibration damping apparatus, comprising a magnetic spring device and a cushioning member such as a metal spring, rubber or the like, can be set to substantially near zero. Thus, the present invention provides a magnetic spring device and a vibration damping apparatus which may be simpler and cheaper to manufacture than the prior art apparatus. Further, a lifting apparatus of the present invention may comprise the magnets only. In this regard, by utilizing repulsion force between the magnets the lifting apparatus of the present invention eliminates the requirement of a linkage and a guide mechanism which are typically required by a conventional lifting apparatus. Therefore, the lifting apparatus of the present invention is simpler and cheaper to manufacture than the prior art apparatus. The lifting apparatus of the present invention is also easier to maintain than the prior art apparatus.

While preferred embodiments of the invention have been described with a certain degree of particularity with reference to the drawings, obvious modifications and variations are possible in light of the above teachings. The scope of the invention is to be determined from the claims appended hereto.

What is claimed is:

1. A magnetic spring device comprising:
at least one movable element made of a magnetic material; and
at least one stationary magnet positioned near said movable element to define a space, in which said movable element travels,
wherein a magnetic force of said stationary magnet causes said movable element to travel within a predetermined range.

2. A magnetic spring device as defined in claim 1, wherein said at least one stationery magnet further comprises a plurality of stationary magnets, which are spaced apart from each other at a predetermined interval.

3. A magnetic spring device as defined in claim 2, wherein said stationary magnets are arranged in such a manner that magnetic polarity of said adjacent stationary magnets is opposite to each other.

4. A magnetic spring device as defined in claim 1, wherein said stationary magnet has a cylindrical shape to form the space.

5. A magnetic spring device as defined in claim 1, wherein said stationary magnet further comprises a plurality of laminated magnets.

6. A magnetic spring device as defined in claim 1, wherein said movable element further comprises a permanent magnet whose magnetic field direction is perpendicular to a magnetic field direction of said stationary magnet.

7. A magnetic spring device as defined in claim 1, wherein said movable element further comprises a permanent magnet whose magnetic field direction is parallel to a magnetic field direction of said stationary magnet.

8. A magnetic spring device as defined in claim 1, wherein said movable element further comprises a plurality of laminated magnets.

9. A magnetic spring device as defined in claim 1, wherein said movable element further comprises a ferromagnetic material, and wherein an elastic constant of said magnetic spring device reverses between a positive value and a negative value at a plurality of points when said movable element travels within the predetermined range.

10. A magnetic spring device as defined in claim 1, wherein said movable element comprises a ferromagnetic material, wherein said movable element reverses its magnetic polarity when said movable element travels within a predetermined range.

11. A lifting apparatus comprising said magnetic spring device defined in any one of claims 1 to 10, wherein an elastic constant of said magnetic spring device has a positive value when said movable element travels within the predetermined range.

12. A vibration damping apparatus being used to support a load mass comprising:
a magnetic spring device defined in any one of claims 1 to 10; and
a cushioning member exerting an elastic force substantially in a moving direction of the load mass,
wherein the load mass is ultimately supported by said movable element of said magnetic spring device,
wherein an elastic constant of said magnetic spring device is negative when said movable element travels within the predetermined range, and
wherein a total elastic constant of said vibration damping apparatus is substantially near zero when said movable element travels within the predetermined range.

13. A lifting apparatus comprising
at least one movable element made of a magnetic material; and
at least one stationary magnet positioned near said movable element to define a space, in which said movable element travels,
wherein a magnetic force of said stationary magnet causes said movable element to travel within a predetermined range,
wherein an elastic constant of said lifting apparatus has a positive value when said movable element travels within the predetermined range.

14. A lifting apparatus as defined in claim 13, wherein said at least one stationery magnet further comprises a plurality of stationary magnets, which are spaced apart from each other at a predetermined interval.

15. A lifting apparatus as defined in claim 14, wherein said stationary magnets are arranged in such a manner that magnetic polarity of said adjacent stationary magnets are opposite to each other.

16. A lifting apparatus as defined in claim 13, wherein said stationary magnet has a cylindrical shape to form the space.

17. A magnetic spring device as defined in claim 13, wherein said stationary magnet further comprises a plurality of laminated magnets, and wherein said movable element further comprises a plurality of laminated magnets.

18. A magnetic spring device as defined in claim 13, wherein said movable element further comprises a permanent magnet whose magnetic field direction is perpendicular to a magnetic field direction of said stationary magnet.

19. A magnetic spring device as defined in claim 13, wherein said movable element further comprises a permanent magnet whose magnetic field direction is parallel to a magnetic field direction of said stationary magnet.

20. A magnetic spring device as defined in claim 13, wherein said movable element comprises a ferromagnetic material, wherein said movable element reverses its magnetic polarity when said movable element travels within a predetermined range.

21. A vibration damping apparatus being used to support a load mass comprising:
at least one movable element made of a magnetic material;
at least one stationary magnet positioned near said movable element to define a space, in which said movable element travels; and
a cushioning member exerting an elastic force substantially in a moving direction of the load mass,
wherein a magnetic force of said stationary magnet causes said movable element to travel within a predetermined range,
wherein the load mass is ultimately supported by said movable element,
wherein an elastic constant of said movable element is negative when said movable element travels within the predetermined range, and
wherein a total elastic constant of said vibration damping apparatus is substantially near zero when said movable element travels within the predetermined range.

22. A vibration damping apparatus as defined in claim 21, wherein said at least one stationery magnet comprises a plurality of stationary magnets, which are spaced apart from each other at a predetermined interval.

23. A vibration damping apparatus as defined in claim 22, wherein said stationary magnets are arranged in such a manner that magnetic polarity of said adjacent stationary magnets is opposite to each other.

24. A vibration damping apparatus as defined in claim 21, wherein said stationary magnet has a cylindrical shape to form the space.

25. A vibration damping apparatus as defined in claim 21, wherein said stationary magnet further comprises a plurality of laminated magnets.

26. A vibration damping apparatus as defined in claim 21, wherein said movable element further comprises a permanent magnet whose magnetic field direction is perpendicular to a magnetic field direction of said stationary magnet.

27. A vibration damping apparatus as defined in claim 21, wherein said movable element further comprises a permanent magnet whose magnetic field direction is parallel to a magnetic field direction of said stationary magnet.

28. A vibration damping apparatus as defined in claim 21, wherein said movable element further comprises a plurality of laminated magnets.

29. A vibration damping apparatus as defined in claim 21, wherein said movable element comprises a ferromagnetic material, wherein said movable element reverses its magnetic polarity when said movable element travels within a predetermined range.

30. A vibration damping apparatus as defined in claim 21, wherein said cushioning member is a coil spring.
